(19) United States
(12) Patent Application Publication
(10) Pub. No.: US 2010/0082357 A1
(43) Pub. Date: Apr. 1, 2010

(54) METHODS, APPARATUSES, AND COMPUTER PROGRAM PRODUCTS FOR PROVIDING ACTIVITY COORDINATION SERVICES

(75) Inventors: Andreas Follmann, Berlin (DE); Stefan Kellner, Berlin (DE); Felix Petersen, Berlin (DE); Klaus Hartl, Berlin (DE); Sean Treadway, Berlin (DE); Tilmann Singer, Vienna (AT); Jeanny Wang, Berlin (DE)

Correspondence Address: DITTHAVONG MORI & STEINER, P.C., 918 Prince Street, Alexandria, VA, 22314, US

(73) Assignee: Nokia Corporation

(21) Appl. No.: 12/241,639

(22) Filed: Sep. 30, 2008

(51) Int. Cl. G06Q 99/00

(52) U.S. Cl. 705/1

(57) ABSTRACT

A method, apparatus, and computer program product are provided, which may provide activity coordination service. An apparatus may include a processor configured to maintain data regarding a user's previous activities and contacts invited to those previous activities. The processor may be further configured to retrieve the maintained data in response to creation of a new activity by the user. The processor may also be configured to determine one or more suggested contacts to invite to the new activity based at least in part upon the maintained data. The processor may additionally be configured to provide the one or more suggested contacts to the user. Corresponding methods and computer program products are also provided.

### TECHNOLOGICAL FIELD

Embodiments of the present invention relate generally to mobile communication technology and, more particularly, relate to methods, apparatuses, and computer program products for providing activity coordination services.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies as well as evolved computing devices making use of networking technologies continue to facilitate ease of information transfer and convenience to users. One area in which there is a demand to further improve the convenience to users is harnessing the connectivity and ready access to information available through expansion of networking technologies for the provision of activity coordination services.

For example, modern computing technologies may facilitate management of, access to, and communication with a user's contacts. Additionally, existing networking and computing technologies may facilitate scheduling and viewing of activities, such as in a calendar application, by computing device users. Computing devices may also be configured to determine a current location of a user, such as through Global Positioning System (GPS) technology. Social networking services, such as Facebook™, MySpace™, and LinkedIn™, may facilitate interaction between a user and contacts. However, users currently lack a system for harnessing available information and integrating various services so as to provide users with a meaningful system for planning, creating, coordinating, and sharing activities with contacts.

Accordingly, it may be advantageous to provide computing device users with methods, apparatuses, and computer program products for providing activity coordination services.

### BRIEF SUMMARY OF SOME EXAMPLES OF THE INVENTION

A method, apparatus, and computer program product are therefore provided, which may provide activity coordination services. In particular, a method, apparatus, and computer program product may be provided to enable, for example, the determination of one or more suggested contacts that a user may desire to invite to an activity. In exemplary embodiments, enhanced location-based activity coordination services may be provided. In this regard, for example, a location of significance (e.g., a location of residence) for a user may be determined and activity coordination services may be tailored based at least in part upon the determined location of significance. Further embodiments may provide other enhanced activity coordination services such that users may create activities and coordinate activity participation with other users of an activity-based service.

In one exemplary embodiment, a method is provided which may include maintaining data regarding a user's previous activities and contacts invited to those previous activities. The method may further include retrieving the maintained data in response to creation of a new activity by the user. The method may also include determining one or more suggested contacts to invite to the new activity based at least in part upon the maintained data. The method may additionally include providing the one or more suggested contacts to the user.

In another exemplary embodiment, a computer program product is provided. The computer program product includes at least one computer-readable storage medium having computer-readable program instructions stored therein. The computer-readable program instructions may include first, second, and third program instructions. The first program instruction is for maintaining data regarding a user's previous activities and contacts invited to those previous activities. The second program instruction is for retrieving the maintained data in response to creation of a new activity by the user. The third program instruction is for determining one or more suggested contacts to invite to the new activity based at least in part upon the maintained data.

In another exemplary embodiment, an apparatus is provided, which may include a processor configured to maintain data regarding a user's previous activities and contacts invited to those previous activities. The processor may be further configured to retrieve the maintained data in response to creation of a new activity by the user. The processor may also be configured to determine one or more suggested contacts to invite to the new activity based at least in part upon the maintained data. The processor may additionally be configured to provide the one or more suggested contacts to the user.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for providing activity coordination services according to an exemplary embodiment of the present invention;

FIG. 2 is a schematic block diagram of a mobile terminal according to an exemplary embodiment of the present invention;

FIG. 3 is an information flow and processing diagram of information that may be received, processed, and sent by an activity-based service provider according to an exemplary embodiment of the present invention; and

FIG. 4 is a flowchart according to an exemplary method for determining suggested contacts to invite to an activity according to an exemplary embodiment of the present invention;

FIG. 5 is a flowchart according to an exemplary method for determining a user's location of residence according to an exemplary embodiment of the present invention; and

FIG. 6 is a flowchart according to an exemplary method for determining a time zone for an activity according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

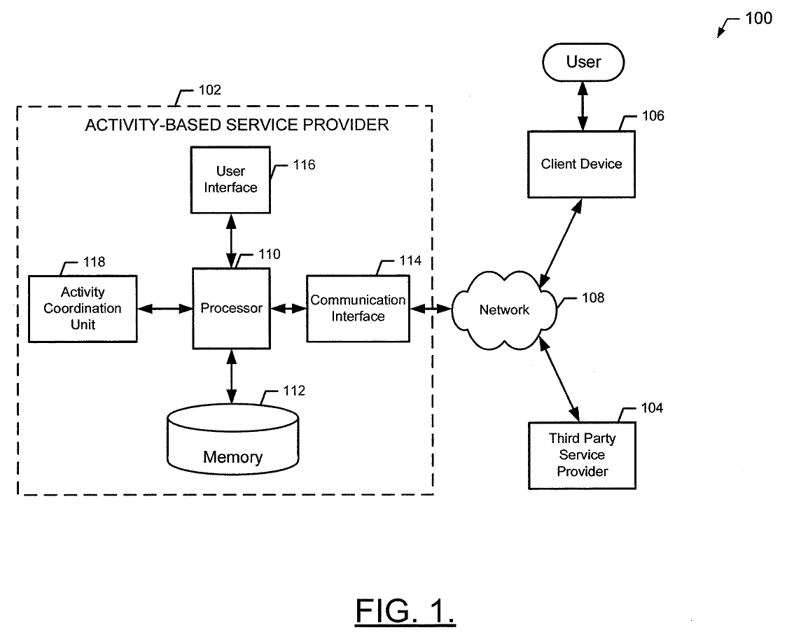

FIG. 1 illustrates a block diagram of a system 100 for providing activity coordination services according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for providing activity coordination services, numerous other configurations may also be used to implement embodiments of the present invention.

As used herein, “activity” refers to a description of any event in which a user may participate. Such an activity may be, for example, a social event, sporting event, performing arts event, business meeting, personal appointment, and/or the like. In an exemplary embodiment, an activity may comprise one or more users participating in the activity, a place (e.g., location) at which the activity will occur, a time at which the activity will occur, an activity type (e.g., a social event, sporting event, performing arts event, business meeting, personal appointment, and/or the like), and/or the like. It will be appreciated that the place may comprise a real world location, a virtual world location, or some combination thereof. In an exemplary embodiment, an activity may be represented digitally as a shareable object that may be spread to contacts so as to inform them of an activity. In this regard, the activity may have a fixed uniform resource locator address associated with it such that users may reference the activity as an address that may be provided to contacts, such as via a message.

As used herein, a “contact” refers to a person with which a user may interact using an activity-based service provider and may be another user of an activity-based service provided by the activity-based service provider. In this regard, a user may invite a contact to participate in an activity. It will be appreciated that a “contact” as used herein need not be previously known to a user and may, but need not be stored in an address book or friend list of a user of an activity-based service provider.

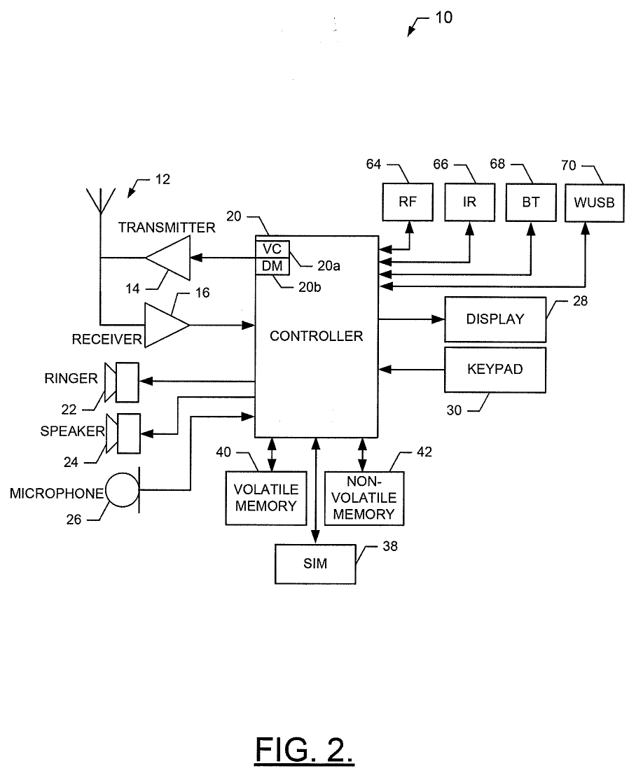

Referring now to FIG. 1, the system 100 may include an activity-based service provider 102, third party service provider 104, and client device 106 configured to communicate over a network 108. The activity-based service provider 102 may be embodied as any computing device or plurality of computing devices configured to provide activity-based services, such as those provided by Plazes.com, which will be described herein below, to users of remote devices, such as a client device 106, over the network 108. In an exemplary embodiment, the activity-based service provider 102 may be embodied as a server or plurality of servers, such as may comprise a server cluster or rack of blade servers. The third party service provider 104 may likewise be embodied as any computing device or plurality of computing devices and in an exemplary embodiment may be embodied as a server or plurality of servers. The third party service provider may be configured to provide any type of service (e.g., a navigation service, social networking service, multimedia service, internet search service, blog service, newsreader service, etc.) to users of remote computing devices, such as, for example users of a client device 106. The activity-based service provider 102 and third party service provider 104 may be further configured to communicate with each other so as to share service information in order to provide more robust and cohesive services to users. The client device 106 may be embodied as any computing device configured to communicate with an activity-based service provider 102 over the network 108 so as to create, manage and access activities. In some embodiments, the client device 106 may be embodied as a mobile computing device, such as, for example a mobile terminal 10 depicted in FIG. 2.

In this regard, FIG. 2 illustrates a block diagram of a mobile terminal 10 representative of one embodiment of a client device 106 in accordance with embodiments of the present invention. It should be understood, however, that the mobile terminal illustrated and hereinafter described is merely illustrative of one type of client device 106 that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth transceiver 68 may be capable of operating according to ultra-low power Bluetooth technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, the client device 106 is not limited to being embodied as a mobile terminal 10 and may be embodied as any computing device, mobile or fixed, and may be embodied as a server, desktop computer, laptop computer, mobile terminal 10, and/or the like. The network 108 may comprise one or more wireless networks, wireline networks, cellular networks, or combination thereof. In an exemplary embodiment, the network 108 may be embodied as or comprise the internet. It will be appreciated that while FIG. 1 illustrates only a single third party service provider 104 and a single client device 106, the system 100 may comprise multiple third party service providers 104 and/or multiple client devices 106.

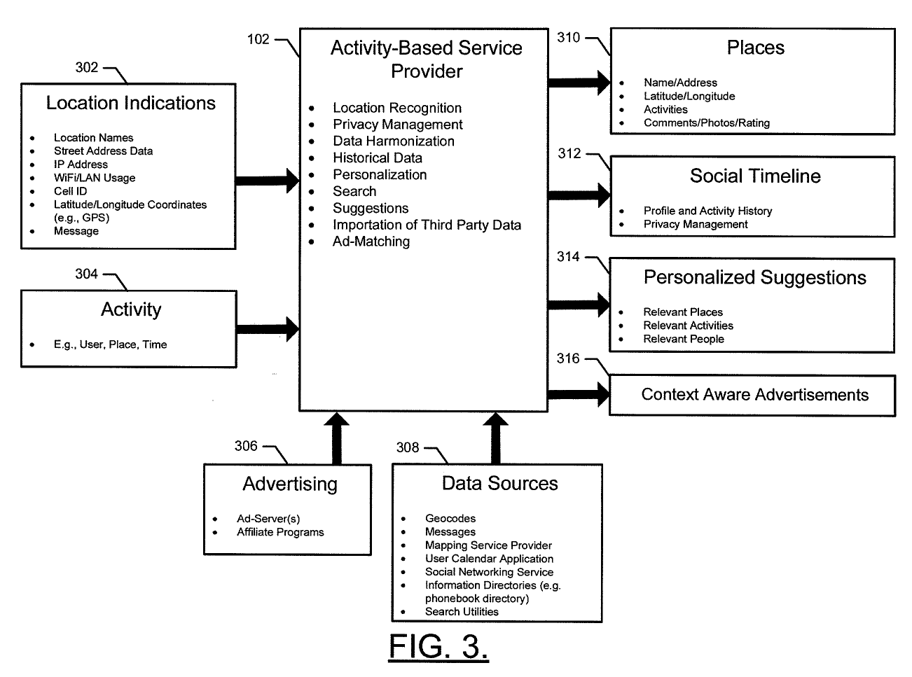

FIG. 3 illustrates a generalized information flow and processing diagram of data and information that may be received, processed, and sent by an activity-based service provider 102 according to an exemplary embodiment of the present invention. It will be appreciated, however, that FIG. 3 is merely for purposes of example and an activity-based service provider 102 may be configured to provide additional services as well as receive, process, and/or send information beyond that shown in FIG. 3. In this regard, an activity-based service provider 102 may be configured to receive various data, such as from a client device 106, third party service provider 104, and/or other device over the network 108. For example, the activity-based service provider 102 may be configured to receive one or more indications of a location of an activity. The location indications (box 302 of FIG. 3) may comprise an indication of a user's current location, such as may be determined from a current position of a client device 106 or may be an indication of a location at which a user will be in the future. Potential location indications may include a location name (e.g., Bob's house, Dave's office, and/or the like), street address data, an internet protocol address that may be correlated to a real world physical address or to a virtual world address, wireless access point usage (e.g. a local access network or the like) that may be correlated to a real world physical address or to a virtual world address, cell identification data identifying a cell from which a user's client device 106 is currently accessing a network, latitude and longitude coordinates such as may be determined by a global positioning system that may be embodied on a client device 106, a message (e.g. a short message service (SMS) message, multimedia messaging service (MMS) message, instant message (IM), e-mail, and/or the like) that may include a natural language indication of a location, and/or the like. Accordingly, the activity-based service provider 102 may be configured to recognize a location from the received location indication(s) and may be configured to associate the location with an activity.

The activity-based service provider 102 may further be configured to receive an activity (box 304 of FIG. 3), which may include associated information regarding time, place or location, user creating or hosting the activity, an activity type, any contacts participating or invited to the activity, and/or the like. The activity may be received, for example, from a client device 106, third party service provider 104, and/or other device over the network 108. A user of the client device 106 may enter the activity information via a user interface of the client device 106 and send the activity to the activity-based service provider. It will be appreciated that the activity-based service provider 102 may be configured to facilitate user entry and transmission of activity information over any number of interfaces, including, for example, a web page that may be loaded in a web browser, a dedicated application, and/or the like. Additionally or alternatively, the activity-based service provider 102 may be configured to receive activity data from a schedule management application, such as, for example, a calendar application, and/or from a third party service provider 104. The activity-based service provider may further be configured to provide sensory creation of activities. In this regard, the activity-based service provider may, for example, determine a user's location from one or more of the location indications above and create an activity associated with the user and the determined location. Sensory creation of activities may further comprise utilizing any data that may be received from a data source.

The activity-based service provider 102 may further be configured to receive data (box 308 of FIG. 3) that may be used by the activity-based service provider 102 to create activities, share activities, coordinate activities, as well as provide meaningful information to remote users about activities from a plurality of data sources. The data sources may comprise or may be embodied on any device accessible to the activity-based service provider 102 over the network 108 and may include, for example, a client device 106, third party service provider 104, cellular network devices that may provide cell ID information, as well as other devices. These data sources may include, for example, geocodes that may associate location data such as may be received as a location indication with a meaningful physical or virtual location, messages (e.g. a short message service (SMS) message, multimedia messaging service (MMS) message, instant message (IM), e-mail, and/or the like), a mapping service provider, a calendar application, a social networking service, an information directory (e.g., a phonebook directory), search utilities, and/or the like. These data sources may be embodied on a client device 106 and/or as a third party service provider 104.

The activity-based service provider 102 may be further configured to receive advertising data (box 306 of FIG. 3), such as from an advertising server, which may be embodied as a third party service provider 104. This advertising data may comprise various advertising content that the activity-based service provider 102 may be configured to match with activities or other user data when providing information to remote users such that users may receive requested information along with related advertising content. In this regard, the activity-based service provider 102 may provide targeted, context aware advertising (box 316 of FIG. 3) based at least in part upon information context. These context aware advertisements may be provided to a client device 106, third party service provider 104, or other device.

The activity-based service provider 102 may be configured to provide a plurality of activity-based services for users of devices such as a client device 106 using the received data and activity information. For example, the activity-based service provider 102 may be configured to provide location recognition such that a meaningful location can be determined from received location indications and associated with an activity. Further, the activity-based service provider 102 may be configured to associate a location with a “place.” In this regard, a “place” may comprise location data, such as, for example, a street address or latitude and longitude coordinates, with context. This context may include information about the place, such as, for example, a name of a resident or property owner if the associated location is a residence (e.g., “Bill's House”) or a business name if it is a business (e.g., “Nokia Headquarters”). Additionally or alternatively, the context information may include activities occurring at and/or scheduled to occur at the place. The context information may further include users that are currently located at the place, scheduled to be located at the place in the future (e.g., for an activity), and/or were previously located at the place (e.g., for an activity). The context information may additionally include user comments about the place, photographs of or related to the place, and/or user ratings of the place. In an exemplary embodiment, a place may be globally defined such that any user accessing information about a location or place may be directed to the associated place as well as associated context information. In this regard, a place may comprise an associated name such that users may identify the place by its name. A place may originally be defined by a user and/or may be defined by the activity-based service provider 102, such as based at least in part upon received activity data and/or location indications. Accordingly, a place may provide context to facilitate social interaction with respect to activities between users of the system 100.

In this regard, the activity-based service provider 102 may be configured to use available location, place, and/or context information to provide place and/or location data (box 310 of FIG. 3) to users of the system 100, such as by sending place data to devices of the system 100. These devices may include, for example, a client device 106, third party service provider 104, as well as other devices, where the place data may be viewed or otherwise accessed by a user. The place data may comprise a place name, address, longitude/latitude coordinates of the place, activities occurring at the place, user comments about the place, photographs of the place, and/or user ratings (e.g., popularity ratings) of the place.

The activity-based service provider 102 may additionally be configured to provide privacy management. In this regard, users may manage privacy settings with respect to how much information is shared with other users. Such information may comprise created activities, user profile information, activities in which the user is participating, historical activity data, places associated with the user, and/or the like. The activity-based service provider 102 may be configured to provide privacy management capabilities such that a user may define different privacy levels for different types of information and/or different groups of contacts (e.g., business contacts, personal contacts, unknown contacts, etc).

The activity-based service provider 102 may further be configured to provide data harmonization. Such data harmonization may include globally updating activity and place information across the system 100. Additionally or alternatively, data harmonization may comprise importing data from and/or exporting data to client devices 106 and/or third party service providers 104 such that data may be harmonized so as to be consistent across a plurality of services and/or applications that may be accessed from or reside on a plurality of devices of the system 100.

Additionally, the activity-based service provider 102 may be configured to aggregate historical data, such as data describing a user's history of activity participation, locations at which the user has been located, and/or the like. This historical data may be provided to the user and/or to contacts with permission to view the user's history, such as in the form of a social timeline (box 312 of FIG. 3). Also, this historical data as well as any associated user profile information, such as personal preferences, may be used by the activity-based service provider 102 to personalize activity-based services provided to the user. This personalization may include personalized suggestions (box 314 of FIG. 3) of relevant places, activities, and/or contacts in which the user may be interested. In an exemplary embodiment, the activity-based service provider may be further configured to provide a search service to users. In this regard, users of remote computing devices, such as a client device 106, may be able to search data stored or accessible by the activity-based service provider 102 for information regarding activities, places, and contacts.

Referring again to FIG. 1, the activity-based service provider 102 may include various means, such as a processor 110, memory 112, communication interface 114, user interface 116, and activity coordination unit 118 for performing the various functions herein described. These means of the activity-based service provider 102 as described herein may be embodied as, for example, hardware elements (e.g., a suitably programmed processor, combinational logic circuit, and/or the like), computer code (e.g., software or firmware) embodied on a computer-readable medium (e.g. memory 112) that is executable by a suitably configured processing device (e.g., the processor 110), or some combination thereof. The processor 110 may, for example, be embodied as various means including a microprocessor, a coprocessor, a controller, or various other processing elements including integrated circuits such as, for example, an ASIC (application specific integrated circuit) or FPGA (field programmable gate array). In an exemplary embodiment, the processor 110 may be configured to execute instructions stored in the memory 112 or otherwise accessible to the processor 110. Although illustrated in FIG. 1 as a single processor, the processor 110 may comprise a plurality of processors operating in parallel, such as a multi-processor system. Such multiple processors may be embodied in a single computing device or may be distributed across multiple computing devices, such as in a server cluster.

The memory 112 may include, for example, volatile and/or non-volatile memory. The memory 112 may be configured to store information, data, applications, instructions, or the like for enabling the activity-based service provider 102 to carry out various functions in accordance with exemplary embodiments of the present invention. For example, the memory 112 may be configured to buffer input data for processing by the processor 110. Additionally or alternatively, the memory 112 may be configured to store instructions for execution by the processor 110. The memory 112 may comprise one or more databases that store information in the form of static and/or dynamic information. In this regard, the memory 112 may store, for example, activities and associated information, places and associated information, user profiles, contacts, and/or the like, such as may be used in an activity-based service. This stored information may be stored and/or used by the activity coordination unit 118 during the course of performing its functionalities.

The communication interface 114 may be embodied as any device or means embodied in hardware, software, firmware, or a combination thereof that is configured to receive and/or transmit data from/to a network, such as the network 108, and/or any other device, such as a third party service provider 104 and/or client device 106, in communication with the activity-based service provider 102. In one embodiment, the communication interface 114 may be at least partially embodied as or otherwise controlled by the processor 110. The communication interface 114 may include, for example, an antenna, a transmitter, a receiver, a transceiver and/or supporting hardware or software for enabling communications with other entities of the system 100, such as a third party service provider 104 and/or client device 106 via the network 108. The communication interface 114 may be configured to receive and/or transmit data using any protocol that may be used for communications between the activity-based service provider 102 and other computing devices of the system 100, such as a third party service provider 104 and/or a client device 106, over the network 108. The communication interface 114 may additionally be in communication with the memory 112, user interface 116, and/or activity coordination unit 118, such as via a bus.

The user interface 116 may be in communication with the processor 110 to receive an indication of a user input and/or to provide an audible, visual, mechanical, or other output to the user. As such, the user interface 116 may include, for example, a keyboard, a mouse, a joystick, a display, a touch screen display, a microphone, a speaker, and/or other input/output mechanisms. However, in an exemplary embodiment wherein the activity-based service provider 102 is embodied as a server, elements of the user interface may be reduced or even eliminated. The user interface 116 may further be in communication with the memory 112, communication interface 116, and/or activity coordination unit 118, such as via a bus.

The activity coordination unit 118 may be embodied as various means, such as hardware, software, firmware, or some combination thereof and, in one embodiment, may be embodied as or otherwise controlled by the processor 110. In embodiments where the activity coordination unit 118 is embodied separately from the processor 110, the activity coordination unit 118 may be in communication with the processor 110. The activity coordination unit 118 may be configured to receive, process, and send data and information related to the provision of activity-based services as discussed above in conjunction with FIG. 3. The activity coordination unit 118 may further be configured to facilitate the creation of a new activity by the user and/or access of an existing activity that the user has permission to access and modify. A “new activity may” include not just an activity that is totally new, but also a new session of an activity that has occurred before and that may occur on a regular or semi-regular basis, such as, for example, a monthly meeting. The activity coordination unit 118 may additionally be configured to receive an indication from a user of contacts that the user wishes to invite to a created and/or accessed activity and to send an invitation to the invited contacts.

In an exemplary embodiment, the activity coordination unit 118 may be configured to maintain data regarding a user's previous activities and contacts invited to those activities by the user. These previous activities may comprise activities created and/or attended by the user. This data may be stored, for example, in the memory 112 in association with the user. In response to creation of a new activity by the user and/or access of an existing activity scheduled to occur in the future (both generalized herein as the “new activity”), the activity coordination unit 118 may be configured to retrieve the maintained data and determine one or more suggested contacts to invite to the activity based at least in part upon the maintained data.

In one embodiment, the activity coordination unit 118 may be configured to determine a predefined number of contacts most frequently invited to a previous activity by the user and suggest those determined contacts to the user to invite to the new activity. In this regard, the activity coordination unit 118 may be configured to determine from the maintained user activity data a number of times each contact which the user has previously invited to an activity has been invited to a previous activity by the user. The activity coordination unit 118 may then be configured to sort the previously invited contacts based at least in part upon the number of times each contact has been invited to a previous activity by the user. For example, the activity coordination unit may be configured to sort contacts in order from the contact who has been invited to the most activities by the user to the contact who has been invited to the fewest activities by the user. The activity coordination unit 118 may then be configured to determine from the sorted contacts a predefined number of contacts that have been invited to the most activities by the user (e.g., the 10 contacts most often invited to the most activities by the user).

In an exemplary embodiment, the activity coordination unit 118 may be configured to determine one or more suggested contacts based at least in part upon an activity type associated with the new activity. In this regard, the activity coordination unit 118 may be configured to search the retrieved maintained data for previous activities having an activity type similar to the new activity. The activity coordination unit 118 may then determine contacts commonly invited by the user to previous activities having an activity type similar to the activity type of the new activity. In this regard, for example, the activity coordination unit 118 may be configured to sort contacts invited to previous activities having a similar activity type based at least in part upon the number of times each contact has been invited to a previous activity having a similar activity type by the user. The activity coordination unit 118 may then be configured to determine a predefined number of contacts most frequently invited to previous activities having a similar activity type to suggest to the user to invite to the new activity. This embodiment may accordingly enhance the value of the suggested contacts provided to the user. For example, a user may have a first group contacts that he frequently invites to business activities and a second group of contacts that he frequently invites to personal activities with little overlap between the two groups of contacts. Accordingly, by configuring the activity coordination unit 118 to determine suggested contacts to invite to a new activity based at least in part upon an activity type, activity-appropriate contacts may be suggested to a user.

The activity coordination unit 118 may further be configured to provide the one or more determined suggested contacts to the user. In this regard, the activity coordination unit 118 may be configured to send the suggested contacts to the client device 106 or otherwise cause the suggested contacts to be displayed on a user interface accessible at the client device, such as, for example, in a web page viewable in a web browser on the client device 106 or in a form field of a dedicated activity-based service application that may be embodied either on the activity-based service provider 102 and accessible to the client device 106 or embodied directly on the client device 106 and in communication with the activity-based service provider 102. Accordingly, a user of the client device 106 may view the suggested contacts on a display operatively coupled to the client device 106 (e.g., a display screen embodied on the client device 106, such as a display 28 of a mobile terminal 10, an external monitor connected to the client device 106, and/or the like). The provided suggested contacts may comprise a short reference to each contact (e.g., a nickname which the user has defined as a reference to a contact, such as may be stored in memory 112) and/or may comprise additional contact information (e.g., name, address, e-mail address, and/or the like). A user of a client device 106 may then review the suggested contacts and select to invite one or more of the suggested contacts as well as contacts that may not have been suggested. Accordingly, the activity coordination unit 118 may further be configured to receive an indication of contacts selected by the user to invite to the activity.

In an exemplary embodiment, the activity coordination unit 118 may be configured to maintain a location history comprising a plurality of location records of locations at which the user has previously been located. In this regard, the activity coordination unit 118 may be configured to determine and store locations (e.g., a listing of locations) at which a user has been present over a period of time, such as in memory 112. This period of time may comprise the duration of the time which the user has used an activity-based service provided by the activity-based service provider (e.g., since registering with the service), or may comprise a predefined period of time immediately preceding the present time (e.g., the previous 90 days). The activity coordination unit 118 may be configured to determine locations at which the user has been present based at least in part upon the user's activity history. In this regard, each activity which a user has scheduled to participate in may comprise an associated location and/or place and thus the activity coordination unit 118 may determine a user to have been present at such an associated location. Additionally or alternatively, the activity coordination unit 118 may be configured to determine locations at which the user has been present through available sensory data that may be provided by and/or accessed from the client device 106 (e.g., GPS detection, cell ID, use of LAN access points, and/or the like) and store the locations as location records in the user's location history, such as in memory 112.

The activity coordination unit 118 may be configured to determine the user's location of residence based at least in part upon the stored location history. For example, the activity coordination unit 118 may be configured to maintain a count of the number of times the user has been present in each historical location and determine the location at which the user has been present the greatest number of times to be the user's location of residence. Additionally or alternatively, the activity coordination unit 118 may be configured store a time duration representing the total amount of time the user has been present at a location in association with each respective location at which the user has been present. In this regard, the activity coordination unit 118 may be configured to determine the location at which the user has spent the greatest duration of time to be the user's location of residence. Once the user's location of residence has been determined, the activity coordination unit 118 may be configured to associate the determined location with a street address, latitude and longitude coordinates, and/or the like. In this regard, the activity coordination unit 118 may determine from received sensory data whether the user is located in his place of residence, such as by comparing the received location indications in the received sensory data to the location of the user's place of residence.

The activity coordination unit 118 may further be configured to take into account a time of day at which the user has been historically present at various locations in determining the user's location of residence and may likewise use a similar technique to determine other locations of significance, such as, for example, the user's location of employment. For example, the activity coordination unit 118 may determine from the user's stored location history the location at which the user has been present the most often during night time hours to be the user's location of residence. The activity coordination unit 118 may be configured to determine the location at which the user has been present the most often during working hours to be the user's place of employment. Once the activity coordination unit 118 has determined a location of significance to a user, the activity coordination unit 118 may be configured to globally define a place associated with that location of significance (e.g., “User's House,” “User's Office,” and/or the like).

The activity coordination unit 118 may be configured to use such determinations of locations of significance to provide location-specific functionality. For example, the activity coordination unit 118 may be configured to automatically generate activities for the user based at least in part upon a sensory determined location known to have significance to the user (e.g., “User is at home,” “User is at work,” and/or the like). In another example, if the user has not visited his place of residence and/or place of employment in a period of time contrary to the user's usual pattern of behavior as may be determined form the user's location history information, the activity coordination unit 118 may be configured to generate an activity based at least in part upon the user's presence in a different location (e.g., “User is on vacation”).

The activity coordination unit 118 may further be configured to offer services to the user based at least in part upon a determined residence and/or employment location. For example, the activity coordination unit 118 may suggest activities created by contacts on the activity-based service that may be located in close proximity to the user's place of residence and/or place of employment. “Close proximity” and “proximate” as used herein may be within any relative distance and may be within a predefined distance defined by the activity-based service provider and/or by the user. In another example, the activity coordination unit 118 may suggest services such as restaurants, stores, businesses, contacts, places, and/or the like that may be located near the user's place of residence and/or place of employment. In an exemplary embodiment, the activity coordination unit 118 may be configured to filter services in close proximity to a location of significance to the user based at least in part upon the user's interests such that services suggested or otherwise offered to the user are more likely to be of interest to the user. In this regard, the activity coordination unit 118 may be configured to determine user's interests from a user's personal profile data, contacts with which the user has interacted, activities which the user has created, activities which the user has attended, and/or the like.

In an exemplary embodiment, the activity coordination unit 118 may be configured to suggest contacts for the user to invite to a new activity based at least in part upon the user's determined location(s) of significance. For example, the activity coordination unit 118 may be configured to determine contacts having a location of residence or otherwise located in close proximity to the user's determined location of residence and/or determined location of employment. The activity coordination unit 118 may then suggest to the user these proximate contacts as potential invitees to a new activity. In an exemplary embodiment, the activity coordination unit 118 may be configured to determine one or more suggested contacts to suggest to the user based at least in part upon a location(s) of significance to the user in combination with any one or more of the methods described above of determining contacts frequently invited to previous activities.

In at least one exemplary embodiment, the activity coordination unit 118 may be configured to determine an appropriate time zone for a location record and/or activity. In this regard, determining the appropriate time zone for a location record and/or activity may be desirable so that, for example, the scheduled time for an activity accessed by a user and/or contact may be accurate as well as so that location records, such as a user's location history, comprise accurate time stamps. In some embodiments, the activity coordination unit 118 may be configured to prompt a user of a client device 106 for an indication of an appropriate time zone and receive an indication from the user. In an exemplary embodiment, however, the activity coordination unit 118 may be configured to automatically determine an appropriate time zone for an activity and/or location record based at least in part upon a determined location of the user and/or a determined location of the client device 106 as a representation of the user's location.

In one embodiment, the activity coordination unit 118 may be configured to automatically determine an appropriate time zone by storing a database of location coordinates, street addresses, cities, towns, countries, and/or the like, such as in memory 112, in conjunction with a corresponding time zone. Accordingly, when the activity coordination unit 118 receives and/or determines a location, such as in conjunction with a location record, activity, and/or place, the activity coordination unit 118 may be configured to look up the location in the database and determine the appropriate time zone for the location.

In another embodiment, the activity coordination unit 118 may be configured to store a plurality of shapes corresponding to an overlay of a non-overlapping section of the Earth's surface. Each section of the Earth's surface and thus each corresponding shape may comprise a time zone. The shapes may be stored in memory 112 and in an exemplary embodiment, may be stored in a spatial relational database. Such a spatial relational database may, for example, be a PostGIS database. The activity coordination unit 118 may be configured to search the shape database for a shape including a location. In this regard, each location may, for example, be defined as comprising a plurality of coordinate points and the activity coordination unit 118 may determine which shape includes the coordinates of the location for which a time zone is unknown. Once the activity coordination unit 118 identifies an appropriate shape including the location, the activity coordination unit 118 may look up the time zone corresponding to the shape and assign that time zone to the location.

The activity coordination unit 118 may be configured to use such determinations of time zones to provide location-specific functionality and/or offer services to a user based at least in part upon a determined time zone. For example, the activity coordination unit 118 may suggest activities created by contacts on the activity-based service that may be located in the determined time zone. In another example, the activity coordination unit 118 may suggest services such as restaurants, stores, businesses, contacts, places, and/or the like that may be located in the time zone. In an exemplary embodiment, the activity coordination unit 118 may be configured to filter services in the time zone based at least in part upon the user's interests such that services suggested or otherwise offered to the user are more likely to be of interest to the user. In this regard, the activity coordination unit 118 may be configured to determine user's interests from a user's personal profile data, contacts with which the user has interacted, activities which the user has created, activities which the user has attended, and/or the like.

In an exemplary embodiment, the activity coordination unit 118 may be configured to suggest contacts for the user to invite to a new activity based at least in part upon a determined time zone for the activity. For example, the activity coordination unit 118 may be configured to determine contacts having a location of residence or otherwise located in the time zone. The activity coordination unit 118 may then suggest to the user these contacts as potential invitees to a new activity. In an exemplary embodiment, the activity coordination unit 118 may be configured to determine one or more suggested contacts to suggest to the user based at least in part upon the determined time zone in combination with any one or more of the methods described above for determining suggested contacts for a user to invite to a new activity.

The activity coordination unit 118 may be configured to further provide for cloning of activities. In this regard, Activities can be cloned e.g. to all activity participants. This way all contacts participating in an activity may control the activity individually and even if the user who created the activity cancels his participation and/or the activity that he created, the entire activity is not deleted for other participants as a cloned activity exists for each participant. The activity coordination unit 118 may be configured to clone an activity by copying the activity object. Accordingly, all of the attributes of the activity object may be copied or cloned. Users may then, for example, modify aspects of the clone or delete the clone without affecting the original activity object. In this regard, there is independent ownership of an activity object. For an example use case, assume there is a birthday party at Big Steak Restaurant. User 1 may be a participant in the activity and have a defined activity object stating that he is going to arrive at Big Steak Restaurant at 7 PM and “eat a nice steak.” User 2 may also participate in the activity and clone User 1's activity object, but modify the cloned object to recite that User 2 is going to “eat a garden salad” without affecting User 1's activity object from which User 2's activity object was cloned. Further, if User 1 should decide to cancel his participation in the birthday party and delete the associated activity object, it does not affect User 2's activity object even though User 2 cloned the activity object from User 1 due to the independent ownership aspect.

The activity coordination unit 118 may additionally be configured to take privacy settings of the activity into account to prevent an accidental disclosure of information protected by the creator of the activity. In this regard, different components of the activity (e.g., time, location, description, type, invited contacts, participating contacts, ability to invite other contacts, and/or the like) may have different access levels (e.g. attending contacts and location may be shown to everyone, but only the creator of the activity and select contacts designated by the creator may have the ability to view notes about the activity).

The activity coordination unit 118 may additionally be configured to clone activities such that all attributes of the activity can be modified by the individual owners of each activity and the individual owner may extend an invitation to contacts to participate in the activity. Further, when one activity is cloned or otherwise derived from the other, the activity coordination unit 118 may record a relationship between them. Recording of the relationship may allow for the visualization and construction of a tree of activities for aggregation purposes. For example, visualization of a relationship between a group of activities may alert a user that an activity he is viewing is actually a clone of an activity the user created and/or is already participating in. The activity coordination unit 118 may additionally or alternatively be configured to determine other relationships between activities based at least in part upon data about how activity objects were cloned, such as, for example, from whom an activity object was cloned. In this regard, the activity coordination unit 118 may be configured to group and/or recommend activities to users based at least in part upon determined relationships between cloned activities and/or a user's own activity history. Accordingly, virality may be provided in that activities may be shared and a user does not necessarily need to know a second user in order to participate in the second user's activities. However, the activity coordination unit 118 may be configured to take into account privacy settings of the second user and may keep aspects of the second user's activities private from at least some other users based upon the second user's privacy settings.

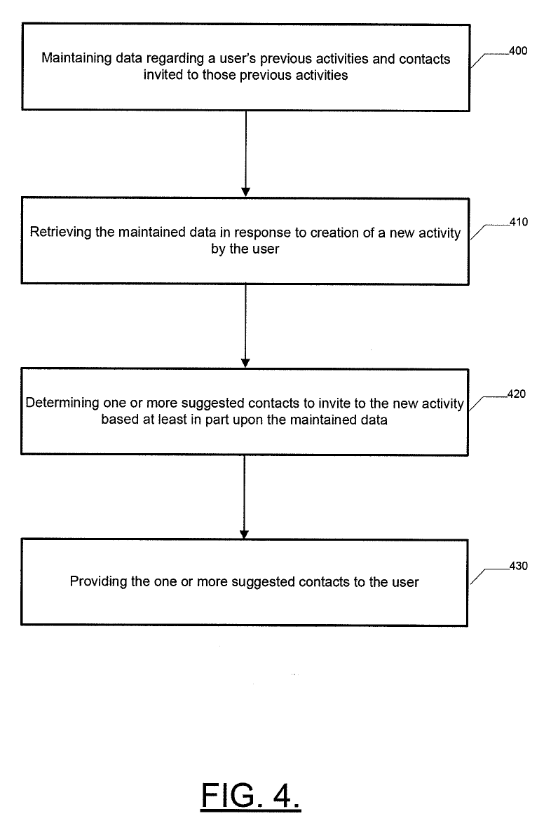

FIGS. 4-6 are flowcharts of systems, methods, and computer program products according to exemplary embodiments of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for determining suggested contacts to invite to an activity according to an exemplary embodiment of the present invention is illustrated in FIG. 4. The method may include the activity coordination unit 118 maintaining data regarding a user's previous activities and contacts invited to those previous activities, at operation 400. Operation 410 may comprise the activity coordination unit 118 retrieving the maintained data in response to creation of a new activity by the user. The activity coordination unit 118 may then determine one or more suggested contacts to invite to the new activity based at least in part upon the maintained data at operation 420. Operation 430 may comprise the activity coordination unit 118 providing the one or more suggested contacts to the user. In this regard, for example, operation 430 may comprise the activity coordination unit 118 providing the one or more suggested contacts to the client device 106 such that the client device 106 may display the one or more suggested contacts on a display screen operatively coupled to the client device 106 and the user may view the one or more suggested contacts on the display screen.

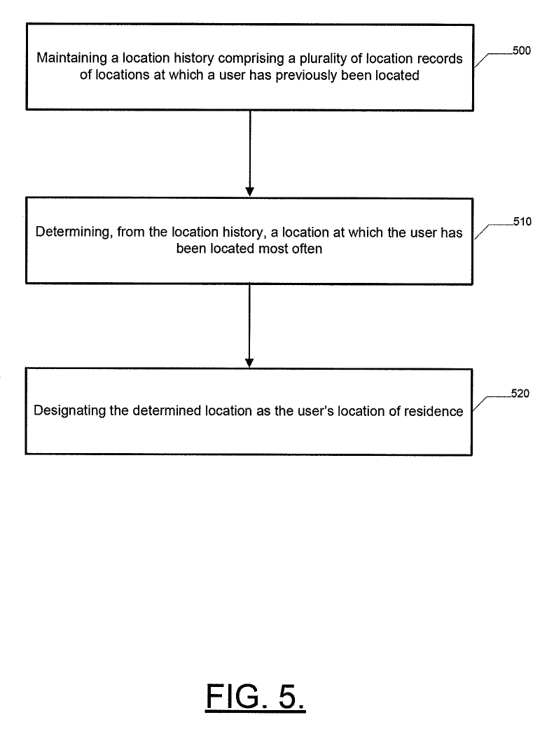

FIG. 5 illustrates one exemplary method for determining a user's location of residence according to an exemplary embodiment of the present invention. The method may include the activity coordination unit 118 maintaining a location history comprising a plurality of location records of locations at which a user has previously been located at operation 500. Operation 510 may comprise the activity coordination unit 118 determining, from the location history, a location at which the user has been located most often. The activity coordination unit 118 may then designate the determined location as the user's location of residence at operation 520. It will be appreciated, however, that this is merely one example of a method for determining a user's location of residence based upon a maintained location history and the invention is not limited to just this method. Indeed, other methods for determining a user's location of residence are described above. Further, other locations of significance to the user, such as a user's location of employment, may be determined in accordance with embodiments of the present invention as well.

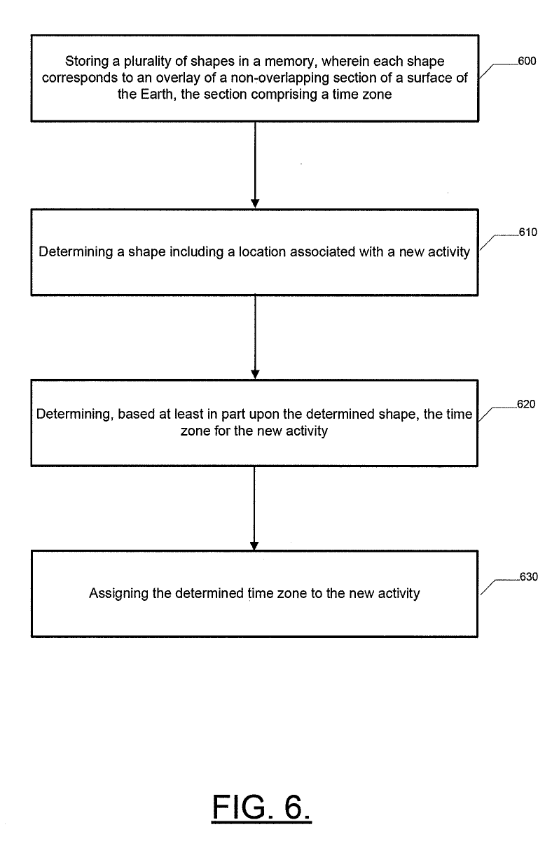

FIG. 6 illustrates an exemplary method for determining a time zone for an activity according to an exemplary embodiment of the present invention. The method may include the activity coordination unit 118 storing a plurality of shapes in memory, such as the memory 112, at operation 600. Each shape may correspond to an overlay of a non-overlapping section of a surface of the Earth and the section may comprise a time zone. Operation 610 may comprise the activity coordination unit 118 determining a shape including a location associated with a new activity. The activity coordination unit 118 may then determine, based at least in part upon the determined shape, the time zone for the new activity at operation 620. Operation 630 may comprise the activity coordination unit 118 assigning the determined time zone to the new activity.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. Embodiments of the invention may provide for activity-based services. In this regard, embodiments of the invention may provide for users to create activities and invite contacts to participate in the created activities. Exemplary embodiments of the invention may suggest one or more contacts to a user to invite to an activity in response to user creation of an activity. The suggested contacts may be determined based at least in part upon contacts that the user has invited to previous activities. In this regard, users may be provided with suggested contacts that the user is likely to invite to a new activity based at least in part upon the user's previous history so as to save the user from having to manually determine contacts to invite to an activity and enter the contact information so that an invitation may be sent to the contact. Some embodiments may additionally provide for location-specific functionality based upon determined locations of significance to a user and/or based upon a determined time zone for an activity. Embodiments of the invention that automatically determine a time zone for a created activity may be beneficial to a user in that the user may not have to manually enter a time zone and local time for an activity.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
maintaining data regarding a user's previous activities and contacts invited to those previous activities;
retrieving the maintained data in response to creation of a new activity by the user; and
determining one or more suggested contacts to invite to the new activity based at least in part upon the maintained data.

2. A method according to claim 1, wherein determining one or more suggested contacts comprises:
determining from the maintained data a number of times each contact has been invited to a previous activity by the user;
sorting the contacts based at least in part upon the number of times each contact has been invited to a previous activity by the user; and
determining from the sorted contacts a predefined number of suggested contacts comprising the predefined number of contacts most frequently invited to a previous activity by the user.

3. A method according to claim 1, wherein determining one or more suggested contacts further comprises:
comparing an activity type associated with the new activity with activity types associated with the user's previous activities to determine one or more previous activities having an associated activity type similar to the activity type associated with the new activity; and
determining one or more suggested contacts to invite to the new activity based at least in part upon contacts invited to the determined one or more previous activities having an associated activity type similar to the activity type associated with the new activity.

4. A method according to claim 1, wherein the new activity comprises an associated location; and
further comprising determining a time zone for the new activity based at least in part upon the associated location.

5. A method according to claim 4, further comprising storing a plurality of shapes in a memory, wherein each shape corresponds to an overlay of a non-overlapping section of a surface of Earth, the section comprising a time zone; and
wherein determining a time zone for the new activity comprises:
determining a shape including the location associated with the new activity; and
determining based at least in part upon the determined shape the time zone for the new activity.

6. A method according to claim 4, wherein determining one or more suggested contacts further comprises determining one or more suggested contacts based at least in part upon the determined time zone for the new activity.

7. A method according to claim 4, further comprising offering a service based at least in part upon the determined time zone for the new activity.

8. A method according to claim 1, further comprising:
maintaining a location history comprising a plurality of location records of locations at which the user has previously been located; and
determining the user's location of residence based at least in part upon the maintained location history.

9. A method according to claim 8, wherein determining the user's location of residence comprises:
determining from the location history, a location at which the user has been located most often; and
designating the determined location as the user's location of residence.

10. A method according to claim 8, wherein determining one or more suggested contacts further comprises determining one or more suggested contacts based at least in part upon the user's location of residence.

11. A method according to claim 8, further comprising offering a service based at least in part upon the user's location of residence.

12. A method according to claim 1, further comprising providing the one or more suggested contacts to a device such that they are displayed on a display operatively coupled to the device.

13. A computer program product comprising at least one computer-readable storage medium having computer-readable program instructions stored therein, the computer-readable program instructions comprising:
a first program instruction for maintaining data regarding a user's previous activities and contacts invited to those previous activities;
a second program instruction for retrieving the maintained data in response to creation of a new activity by the user; and
a third program instruction for determining one or more suggested contacts to invite to the new activity based at least in part upon the maintained data.

14. A computer program product according to claim 13, wherein the third program instruction includes instructions for:
determining from the maintained data a number of times each contact has been invited to a previous activity by the user;
sorting the contacts based at least in part upon the number of times each contact has been invited to a previous activity by the user; and
determining from the sorted contacts a predefined number of suggested contacts comprising the predefined number of contacts most frequently invited to a previous activity by the user.

15. A computer program product according to claim 13, wherein the third program instruction includes instructions for:
comparing an activity type associated with the new activity with activity types associated with the user's previous activities to determine one or more previous activities having an associated activity type similar to the activity type associated with the new activity; and
determining one or more suggested contacts to invite to the new activity based at least in part upon contacts invited to the determined one or more previous activities having an associated activity type similar to the activity type associated with the new activity.

16. A computer program product according to claim 13, wherein the new activity comprises an associated location; and further comprising:
a fourth program instruction for determining a time zone for the new activity based at least in part upon the associated location.

17. A computer program product according to claim 16, further comprising a fifth program instruction for storing a plurality of shapes in a memory, wherein each shape corresponds to an overlay of a non-overlapping section of a surface of Earth, the section comprising a time zone; and
wherein the fourth program instruction includes instructions for:
determining a shape including the location associated with the new activity; and
determining based at least in part upon the determined shape the time zone for the new activity.

18. A computer program product according to claim 16, wherein the third program instruction includes instructions for determining one or more suggested contacts based at least in part upon the determined time zone for the new activity.

19. A computer program product according to claim 16, further comprising a fifth program instruction for offering a service based at least in part upon the determined time zone for the new activity.

20. A computer program product according to claim 13, further comprising:
a fourth program instruction for maintaining a location history comprising a plurality of location records of locations at which the user has previously been located; and
a fifth program instruction for determining the user's location of residence based at least in part upon the maintained location history.

21. A computer program product according to claim 20, wherein the fifth program instruction includes instructions for:
determining from the location history, a location at which the user has been located most often; and
designating the determined location as the user's location of residence.

22. A computer program product according to claim 20, wherein the third program instruction includes instructions for determining one or more suggested contacts based at least in part upon the user's location of residence.

23. A computer program product according to claim 20, further comprising a sixth program instruction for offering a service based at least in part upon the user's location of residence.

24. An apparatus comprising a processor configured to:
maintain data regarding a user's previous activities and contacts invited to those previous activities;
retrieve the maintained data in response to creation of a new activity by the user; and
determine one or more suggested contacts to invite to the new activity based at least in part upon the maintained data.

25. An apparatus according to claim 24, wherein the processor is configured to determine one or more suggested contacts by:
determining from the maintained data a number of times each contact has been invited to a previous activity by the user;
sorting the contacts based at least in part upon the number of times each contact has been invited to a previous activity by the user; and
determining from the sorted contacts a predefined number of suggested contacts comprising the predefined number of contacts most frequently invited to a previous activity by the user.

26. An apparatus according to claim 24, wherein the processor is configured to determine one or more suggested contacts by:
comparing an activity type associated with the new activity with activity types associated with the user's previous activities to determine one or more previous activities having an associated activity type similar to the activity type associated with the new activity; and
determining one or more suggested contacts to invite to the new activity based at least in part upon contacts invited to the determined one or more previous activities having an associated activity type similar to the activity type associated with the new activity.

27. An apparatus according to claim 24, wherein the new activity comprises an associated location; and
wherein the processor is further configured to determine a time zone for the new activity based at least in part upon the associated location.

28. An apparatus according to claim 27, wherein the processor is further configured to store a plurality of shapes in a memory, wherein each shape corresponds to an overlay of a non-overlapping section of a surface of Earth, the section comprising a time zone; and
wherein the processor is configured to determine a time zone for the new activity by:
determining a shape including the location associated with the new activity; and
determining based at least in part upon the determined shape the time zone for the new activity.

29. An apparatus according to claim 27, wherein the processor is further configured to determine one or more suggested contacts based at least in part upon the determined time zone for the new activity.

30. An apparatus according to claim 27, wherein processor is further configured to offer a service based at least in part upon the determined time zone for the new activity.

31. An apparatus according to claim 24, wherein the processor is further configured to:
maintain a location history comprising a plurality of location records of locations at which the user has previously been located; and
determine the user's location of residence based at least in part upon the maintained location history.

32. An apparatus according to claim 31, wherein the processor is configured to determine the user's location of residence by:
determining from the location history, a location at which the user has been located most often; and
designating the determined location as the user's location of residence.

33. An apparatus according to claim 31, wherein the processor is further configured to determine one or more suggested contacts based at least in part upon the user's location of residence.

34. An apparatus according to claim 31, wherein the processor is further configured to offer a service based at least in part upon the user's location of residence.

35. An apparatus according to claim 24, wherein the processor is further configured to provide the one or more suggested contacts to a device such that they are displayed on a display operatively coupled to the device.
